(19) United States
(12) Patent Application Publication
(10) Pub. No.: US 2025/0158258 A1
(43) Pub. Date: May 15, 2025

(54) BATTERY PACK WITH SUPPRESSANT DISTRIBUTION VOLUME

(71) Applicant: Tyco Fire Products LP, Cranston, RI (US)

(72) Inventors: Sean S. Troutt, Stephenson, MI (US); Blake Bomann, Greenville, WI (US); Ben Markovitz, Howard, WI (US); David Strobel, Marinette, WI (US)

(73) Assignee: Tyco Fire Products LP, Cranston, RI (US)

(21) Appl. No.: 18/839,247

(22) PCT Filed: Mar. 23, 2023
(86) PCT No.: PCT/IB2023/052893

§ 371 Date: Aug. 16, 2024

Related U.S. Application Data
(60) Provisional application No. 63/323,634, filed on Mar. 25, 2022.

(51) Int. Cl. H01M 50/673; A62C 3/07; A62C 3/16; H01M 10/613; H01M 50/249; H01M 50/636

(52) U.S. Cl. CPC H01M 50/673; A62C 3/07; A62C 3/16; H01M 10/613; H01M 50/249; H01M 50/636; H01M 2200/10; H01M 2200/20

(57) ABSTRACT

A battery system includes a housing assembly including an inner wall and an outer wall and a battery section. The housing assembly defines an inner volume, a distribution volume extending between the inner wall and the outer wall, the inner wall extending between the inner volume and the distribution volume, a first aperture and a second aperture each extending through the inner wall from the inner volume to the distribution volume, and an inlet fluidly coupled to the distribution volume and configured to be fluidly coupled to a supply of fire suppressant. The battery section is positioned within the inner volume.

### CROSS-REFERENCE TO RELATED PATENT APPLICATION

This application claims the benefit of and priority to U.S. Provisional Application No. 63/323,634, filed on Mar. 25, 2022, the entire disclosure of which is hereby incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, making it difficult for an external source of fire suppressant to reach the cells.

### SUMMARY

At least one embodiment relates to a battery system including a housing assembly including an inner wall and an outer wall and a battery section. The housing assembly defines an inner volume, a distribution volume extending between the inner wall and the outer wall, the inner wall extending between the inner volume and the distribution volume, a first aperture and a second aperture each extending through the inner wall from the inner volume to the distribution volume, and an inlet fluidly coupled to the distribution volume and configured to be fluidly coupled to a supply of fire suppressant. The battery section is positioned within the inner volume.

A battery system includes an outer housing portion defining an inlet, an inner housing portion positioned within the outer housing portion such that a gap volume is defined between the inner housing portion and the outer housing portion, the inner housing portion defining an inner volume and a perforation fluidly coupling the inner volume to the gap volume, a battery section positioned within the inner volume, and a suppressant container fluidly coupled to the inlet. The suppressant container is configured to supply fire suppressant along a flow path extending through the inlet, the gap volume, and the perforation and into the inner volume.

A battery system includes an outer housing defining an inlet and an inner housing positioned within the outer housing such that a gap volume is defined between the inner housing and the outer housing. The inner housing defines an inner volume, a first aperture fluidly coupling the inner volume to the gap volume, and a second aperture fluidly coupling the inner volume to the gap volume. The inner housing has a first face and an opposing second face each exposed to the gap volume. The battery system further includes a first battery section and a second battery section each positioned within the inner volume, a first seal extending across the first aperture and configured to rupture in response to a hazard event associated with the first battery section, a second seal extending across the second aperture and configured to rupture in response to a hazard event associated with the second battery section, and a suppressant container fluidly coupled to the inlet. The suppressant container is configured to supply fire suppressant to the inner volume through the inlet, the gap volume, the first aperture, and the second aperture.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a battery system, according to an exemplary embodiment.

FIG. 2 is a block diagram of a control system for the battery system of FIG. 1, according to an exemplary embodiment.

FIG. 3 is a left side view of a vehicle utilizing the battery system of FIG. 1, according to an exemplary embodiment.

FIG. 4 is a perspective view of a containerized energy storage system including the battery system of FIG. 1, according to an exemplary embodiment.

FIG. 5 is a front section view of a housing for the battery system of FIG. 1, according to an exemplary embodiment.

FIG. 6 is a front section view of the housing of FIG. 5 illustrating a flow path of fire suppressant.

FIG. 7 is a perspective section view of the housing of FIG. 5.

FIG. 8 is a perspective view of an inner housing of the housing of FIG. 5.

FIG. 9 is a front section view of a housing for the battery system of FIG. 1, according to another exemplary embodiment.

FIG. 10 is a perspective section view of a conduit for the battery system of FIG. 1, according to an exemplary embodiment.

FIG. 11 is a front section view of a housing for the battery system of FIG. 1, according to another exemplary embodiment.

FIG. 12 is a front section view of a housing for the battery system of FIG. 1, according to another exemplary embodiment.

FIG. 13 is a front section view of a housing for the battery system of FIG. 1, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, an enclosure or housing for a battery system includes an inner housing received by an outer housing. The inner housing in turn defines an inner volume that receives a series of battery sections, such as battery cells. A gap volume is formed between the inner housing and the outer housing. The outer housing defines an inlet, through which fire suppressant can be introduced into the gap volume. The inner housing defines a series of perforations that are spaced along the inner volume. In operation, fire suppressant is received within and spreads throughout the gap volume, reaching each of the perforations. The fire suppressant than passes through the perforations and into the inner volume containing the battery sections. Beneficially, the housing is capable of distributing a flow of fire suppressant throughout the inner volume. Further, the housing accomplishes this without the need for additional conduits, making the system more compact.

### System Overview

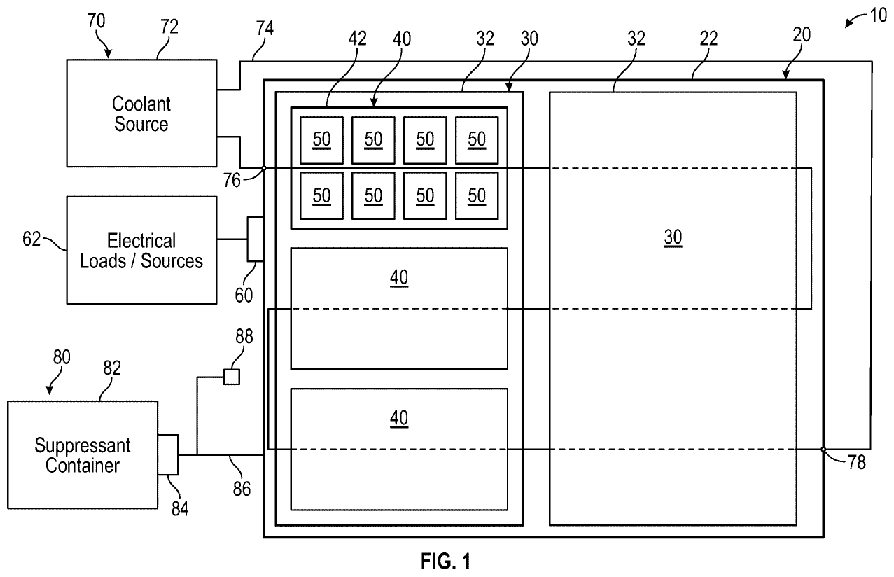

Referring to FIG. 1, a power system or battery system, shown as system 10, includes an energy storage device, energy storage assembly, battery assembly, power source, or electrical energy source, shown as battery pack 20, according to an exemplary embodiment. The battery pack 20 is configured to store energy (e.g., chemically) and later discharge the stored energy as electrical energy to power one or more electrical loads (e.g., electric motors, resistive elements, lights, speakers, etc.). In some embodiments, the battery pack 20 is rechargeable using electrical energy (e.g., from an electrical grid, from a fuel cell, from a solar panel, from an electrical motor being driven as a generator, etc.).

The battery pack 20 includes a shell or housing, shown as pack housing 22, that defines a volume containing components of the battery pack 20 (e.g., the subpacks 30). The pack housing 22 may seal the components of the battery pack 20 from the surrounding environment (e.g., limiting or preventing ingress of water or dust). The pack housing 22 may define one or more ports to facilitate transfer of electrical energy, coolant, fire suppressant, or other material into or out of the battery pack 20.

The battery pack 20 includes a series of battery portions or sections, shown as subpacks 30. By way of example, the battery pack 20 may include four subpacks 30. In other embodiments, the battery pack 20 includes more or fewer subpacks 30. Each subpack 30 is configured to store a portion of the stored energy of the battery pack 20. Each subpack 30 includes a housing 32 containing components of the subpack 30 (e.g., the battery modules 40).

Each subpack 30 includes a series of battery portions or sections, shown as battery modules 40. By way of example, each subpack 30 may include eight battery modules 40. In other embodiments, each subpack 30 includes more or fewer battery modules 40. Each battery module 40 is configured to store a portion of the stored energy of the corresponding subpack 30. Each battery module 40 includes a housing 42 containing components of the battery module 40 (e.g., the battery cells 50).

Each battery module 40 includes a series of battery portions or sections, shown as battery cells 50. By way of example, each battery module 40 may include hundreds of battery cells 50. In other embodiments, each battery module 40 includes more or fewer battery cells 50. Each battery cell 50 is configured to store a portion of the energy stored by the corresponding battery module 40.

In some embodiments, the battery cells 50 are lithium-ion (i.e., Li-ion) battery cells. Each battery cell 50 may be configured to receive electrical energy, store the received energy chemically, and release the stored electrical energy. As shown in FIG. 1, the battery cells 50 are arranged in rows adjacent one another within the battery module 40, reducing empty space within the battery module 40 and reducing the overall size of the battery pack 20. The battery cells 50 may be cylindrical cells, prismatic cells, pouch cells, or another form factor of battery cells.

The battery cells 50 may be electrically coupled to one another within the battery pack 20. By way of example, in one arrangement (a) the battery cells 50 within each battery module 40 are electrically coupled to one another, (b) the battery modules 40 within each subpack 30 are electrically coupled to one another, and (c) the subpacks 30 are electrically coupled to one another. The collective arrangement of battery cells 50, battery modules 40, and subpacks 30 is electrically coupled to a connector or port, shown as electrical port 60. The electrical port 60 electrically couples the battery cells 50 to one or more electrical sources and/or loads, shown as electrical loads/sources 62. The battery cells 50 may be discharged through the electrical port 60 to power the electrical loads/sources 62. The battery cells 50 may receive electrical energy through the electrical port 60 to charge the battery cells 50.

The battery cells 50, the battery modules 40, and the subpacks 30 may be arranged in series/parallel to control the output voltage of the battery pack 20 at the electrical port 60 and the capacity of the battery pack 20 at that output voltage. Battery cells 50 may be arranged in series with one another to increase an output voltage of the battery pack 20. Battery cells 50 may be arranged in parallel with one another to increase the capacity (e.g., measured in amp-hours) of the battery pack 20. By way of example, the battery modules 40 within each subpack 30 may be connected to one another in series, forming a string. The subpacks 30 may be connected to one another in parallel, such that the strings are connected in parallel.

In other embodiments, the battery pack 20 is otherwise arranged. By way of example, the battery pack 20 may include more or fewer battery cells 50, battery modules 40, and/or subpacks 30. By way of another example, the battery cells 50, battery modules 40, and/or subpacks 30 may be arranged in rows, columns, helical patterns, or otherwise positioned within the pack housing 22. In some embodiments, the subpacks 30 are omitted, and the battery modules 40 are positioned directly within the battery pack 20.

In some embodiments, the system 10 includes a cooling subsystem, shown as cooling system 70. The cooling system 70 includes a coolant source 72 that is configured to supply a flow of coolant to one or more conduits, shown as cooling channels 74. The coolant source 72 may include pumps, reservoirs, valves, and/or other components that facilitate handling the coolant. The coolant source 72 may also include one or more radiators or heat exchangers that facilitate discharging thermal energy from the coolant (e.g., to the surrounding atmosphere).

The cooling channels 74 pass into the pack housing 22 at an inlet 76 and exit the pack housing 22 at an outlet 78. The cooling channels 74 pass through the housings 32 of the subpacks 30 and the housings 42 of the battery modules 40 and pass adjacent (e.g., in contact with) the battery cells 50. In some embodiments, at least a portion of the cooling channels 74 is contained within and/or pass along the walls of the pack housing 22, the housings 32, and/or housings 42. The cooling channels 74 facilitate conduction between the coolant and the battery cells 50, such that thermal energy generated by the battery cells 50 (e.g., when charging or discharging electrical energy) is transferred to the coolant. The flow of coolant then transfers the thermal energy back to the coolant source 72 to be discharged. Accordingly, the cooling system 70 facilitates maintaining a consistent, low operating temperature of the battery pack 20.

Referring to FIG. 1, the system 10 further includes a fire suppression system, fire prevention system, or fire mitigation system, shown as suppression system 80. The suppression system 80 is configured to address fires within the battery pack 20 by supplying a fire suppressant. The suppressant may suppress active fires (e.g., preventing the fire from accessing oxygen). The suppressant may also cool the battery cells 50, preventing later ignition or reignition of the battery cells. The suppression system 80 may advantageously prevent, address, or otherwise mitigate thermal runaway of the battery cells 50.

The suppression system 80 includes a container of suppressant (e.g., a tank, a vessel, a cartridge, a reservoir, etc.) or fire suppressant source, shown as suppressant container 82. The suppressant may be held at an elevated pressure to facilitate dispensing the suppressant. The suppressant may include a gas (e.g., an inert gas, nitrogen, etc.), a liquid suppressant (e.g., water), a gel suppressant, a dry chemical suppressant, another type of suppressant, or combinations thereof.

The suppression system 80 further includes an actuator, shown as activator 84, that is configured to initiate a transfer (e.g., a flow) of fire suppressant from the suppressant container 82 to the battery pack 20. By way of example, the activator 84 may include a valve or seal puncture actuator that selectively permits suppressant to flow out of the suppressant container 82. By way of another example, the activator 84 may include a seal (e.g., one of the seals 302) that is configured to rupture in response to a predetermined condition (e.g., an elevated temperature, an elevated pressure, exposure to a predetermined substance, etc.). By way of another example, the activator 84 may include a pump that is configured to impel the flow of suppressant. As shown in FIG. 1, the activator 84 is positioned adjacent the suppressant container 82. Alternatively, the activator 84 may be positioned anywhere along the distribution network 86 or adjacent the battery pack 20. In some embodiments, the fire suppression system 80 includes multiple activators 84 (e.g., each controlling the flow of fire suppressant through a different branch of the distribution network 86). By way of example, each branch of the distribution network 86 may include a zone valve that controls whether or not the branch is fluidly coupled to the suppressant container 82. The zone valves may be integrated into a common housing to form a flow control manifold.

The suppression system 80 further includes one or more conduits (e.g., pipes, hoses, tubes, etc.), shown as distribution network 86, that is configured to transfer suppressant from the suppressant container 82 to the battery pack 20. The distribution network 86 may transfer the suppressant to the interior of the battery pack 20 (e.g., inside the pack housing 22, inside the housing 32, inside the housing 42, etc.). Additionally or alternatively, the distribution network 86 may transfer the suppressant to the exterior of the battery pack 20. By way of example, the distribution network 86 may provide the suppressant to an outlet, shown as nozzle 88, that is positioned to direct suppressant to the exterior of the pack housing 22.

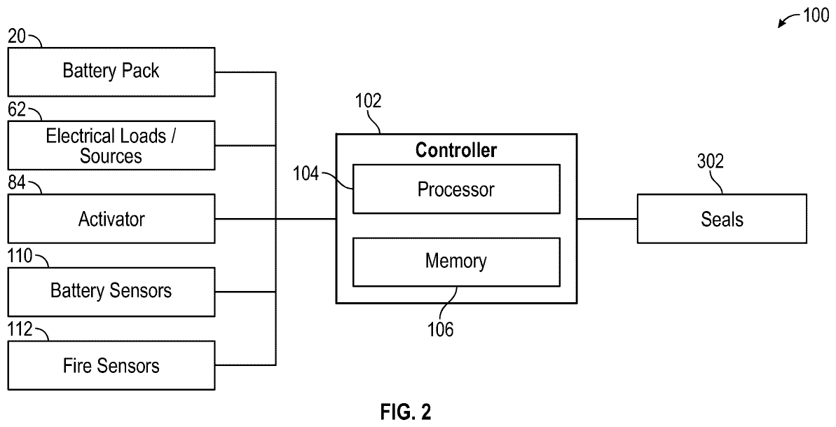

Referring to FIG. 2, a control system 100 of the system 10 is shown according to an exemplary embodiment. The control system 100 includes a processing circuit, shown as controller 102, including a processor 104 and a memory 106. The processor 104 may execute one or more instructions stored within the memory 106 to perform any of the functions described herein.

As shown, the controller 102 is operatively coupled to the battery pack 20, the electrical loads/sources 62, and the activator 84. The controller 102 may be configured to control operation of the battery pack 20 (e.g., as a battery management system), the electrical loads/sources 62, the suppression system 80, or any other component of the system 10. By way of example, the controller 102 may control charging and/or discharging of the battery pack 20. By way of another example, the controller 102 may control activation of the suppression system 80 to address one or more fires.

The control system 100 further includes one or more sensors, shown as battery sensors 110, operatively coupled to the controller 102. The battery sensors 110 may be configured to provide sensor data measuring one or more parameters related to the performance of the battery pack 20. By way of example, the battery sensors 110 may measure a current, voltage, and/or charge level within the battery pack 20. The battery sensors 110 may measure performance at the battery cell 50 level, the battery module 40 level, the subpack 30 level, and/or the battery pack 20 level. In some embodiments, the controller 102 is configured to use information from the battery sensors 110 to detect or predict a thermal event (e.g., a fire) associated with the battery pack 20. By way of example, the controller 102 may identify a change in measured current, voltage, or charge level that is indicative of a fire.

The control system 100 further includes one or more sensors, shown as thermal event sensors 112, configured to detect or predict a thermal event (e.g., a fire) associated with the battery pack 20. By way of example, the thermal event sensors 112 may include temperature sensors configured to detect an increase in temperature (e.g., of one of the battery cells 50) associated with a fire or a prediction of a fire. By way of another example, the thermal event sensors 112 may include an aspirating smoke detector that is configured to identify the presence of smoke or a gas that is produced (e.g., offgassed) when the battery cells 50 are above the standard operating temperature range. By way of another example, the thermal event sensors 112 may include an optical sensor that detects light produced by a fire.

In response to detection or prediction of a fire, the controller 102 may activate the suppression system 80 to address (e.g., prevent or suppress) the fire. By way of example, the controller 102 may actuate the activator 84 to direct suppressant to the battery pack 20. This suppressant may enter and/or surround the battery pack 20, addressing the fire.

Although a single controller 102 is shown in FIG. 2, it should be understood that the functionality of the controller 102 may be distributed across two or more separate controllers in communication with one another. By way of example, a first controller (e.g., a battery controller) may be dedicated for the battery management (e.g., controlling power usage from the battery cells 50 and charging of the battery cells 50). A second controller (e.g., a fire system controller) may be dedicated for management of the suppression system 80 (e.g., control over the activator 84 and the thermal event sensors 112). The two controllers would have the ability to communicate with each other such that when the fire system controller detects a fire, the fire system controller provides a signal to the battery controller. This signal commands the battery controller to disconnect or shut down usage of the affected batteries (e.g., battery packs 20, subpacks 30, battery modules 40, and/or battery cells 50) prior to discharging the suppression system 80.

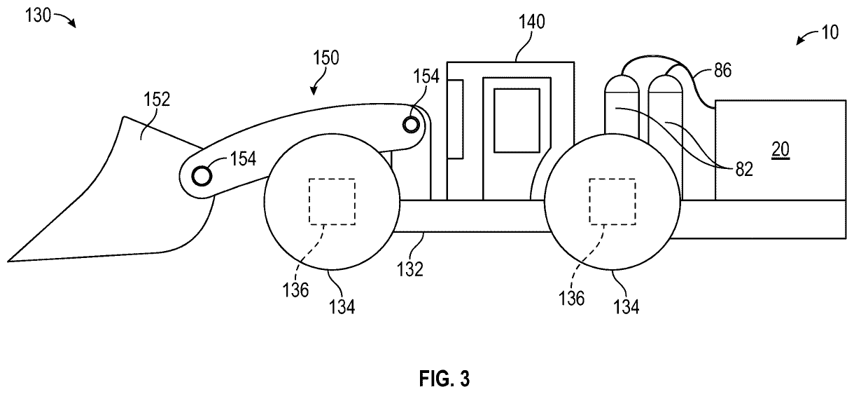

Referring to FIG. 3, a vehicle 130 is equipped with the system 10, according to an exemplary embodiment. As shown, the vehicle 130 is configured as a mining vehicle. Specifically, the vehicle 130 is configured as a front end loader. In other embodiments, the vehicle 130 is configured as another type of vehicle, such as a forestry vehicle, a passenger vehicle (e.g., a bus), a boat, or yet another type of vehicle.

The vehicle 130 includes a frame, shown as chassis 132, that is coupled to and supports a battery pack 20 and a pair of suppressant containers 82. The vehicle 130 includes a series of tractive elements (e.g., wheel and tire assemblies), shown as tractive elements 134, that are rotatably coupled to the chassis 132. The tractive elements 134 engage a support surface (e.g., the ground) to support the vehicle 130. The tractive elements 134 are coupled to a series of electric actuators or prime movers, shown as drive motors 136. The drive motors 136 are configured to drive the tractive elements 134 to propel the vehicle 130. In some embodiments, the drive motors 136 are electrically coupled to the battery pack 20. The drive motors 136 may consume electrical energy from the battery pack 20 (e.g., when propelling the vehicle 130) and/or provide electrical energy to charge the battery pack 20 (e.g., when performing regenerative braking).

The vehicle 130 further includes an operator compartment or cabin, shown as cab 140, that is coupled to the chassis 132. The cab 140 may be configured to contain one or more operators of the vehicle 130. The cab 140 may include one or more user interface elements (e.g., steering wheels, pedals, shifters, switches, knobs, dials, screens, indicators, etc.) that facilitate operation of the vehicle 130 by an operator.

The vehicle 130 further includes an implement assembly 150 coupled to the chassis 132. As shown, the implement assembly 150 includes an implement, shown as bucket 152. The implement assembly 150 further includes one or more actuators (e.g., electric motors, electric linear actuators, etc.), shown as implement actuators 154, that are configured to cause movement of the bucket 152 relative to the chassis 132. The implement actuators 154 may be electrically coupled to the battery pack 20. The implement actuators 154 may consume electrical energy from the battery pack 20 (e.g., when moving the bucket 152) and/or provide electrical energy to charge the battery pack 20 (e.g., when slowing the movement of the bucket 152).

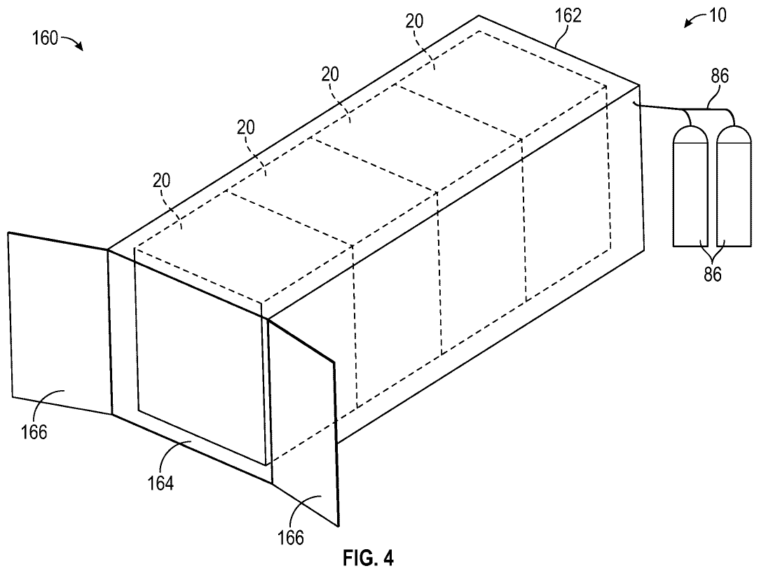

Referring to FIG. 4, a containerized energy storage system, shown as container system 160, is equipped with the system 10, according to an exemplary embodiment. In some embodiments, the container system 160 is configured to store energy to power one or more external electrical loads. The container system 160 may be portable (e.g., using a crane, using a container ship, using a semi truck, etc.).

As shown, the container system 160 includes a container, shown as shipping container 162, defining an internal volume 164. The internal volume 164 is selectively accessible from outside of the shipping container 162 through one or more doors 166. The internal volume 164 contains a series of battery packs 20 coupled to the shipping container 162. The battery packs 20 may be electrically coupled to one another, providing a large energy storage capacity.

Battery Pack with Suppressant Distribution Volume

According to an exemplary embodiment, a battery enclosure includes perforated walls to permit uniform rapid firefighting agent delivery in areas with minimal access with minimal agent loss. Batteries typically have minimal amounts of free space and difficult to access points of hazard initiation (e.g., the location where a thermal event begins). The battery enclosure permits agent to be distributed over a maximized area, thereby minimizing the time it takes for the agent to move from the inlet of the enclosure to the seed of the fire or the location of the cell experiencing thermal runaway and/or thermal or fire propagation. The enclosure could be modified to fit individual potential hazard locations. The enclosure also minimizes or eliminates bulky agent delivery piping. The enclosure may be configured to use a wide variety of agent types including solid, liquid and gaseous agents. The enclosure may also permit the delivery of multiple agents simultaneously, such as a gaseous agent to rapidly knock down fire and a liquid agent to provide cooling and long term suppression.

The enclosure may mitigate thermal runaway and/or reduce the potential for thermal runaway or fire propagation by rapidly applying agent over a wide area. This improves fire suppression performance relative to a system in which agents are applied by external nozzles, which would have a smaller number of locations for introducing agent and would introduce agent a greater distance away from the start of the fire and/or thermal runaway or propagation. Another problem that battery system designers often face with other systems is the determination of an optimal nozzle location. Due to the large quantity of perforations in the enclosure, determination of an optimal nozzle location would not be required with the enclosure.

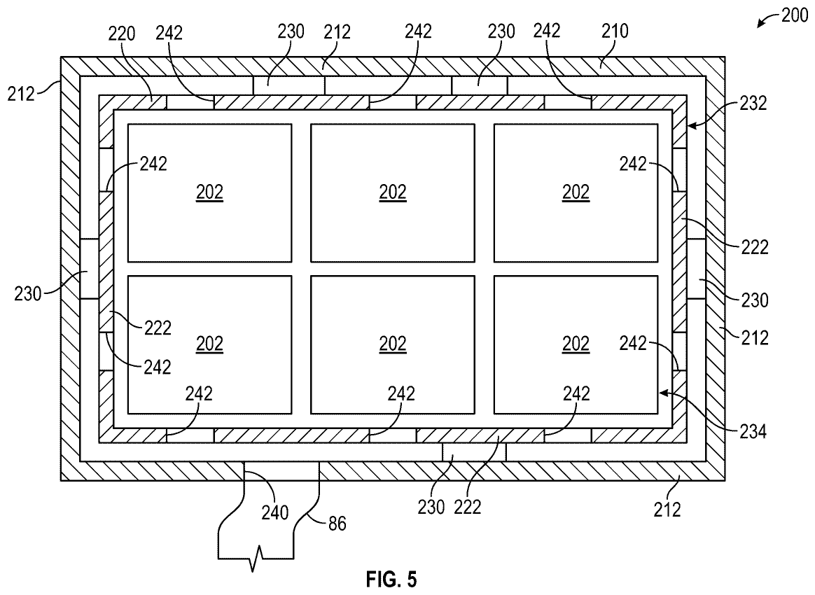

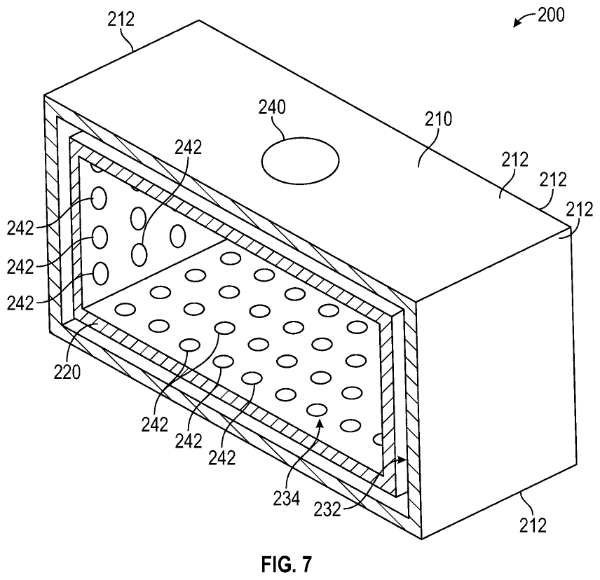

Referring to FIGS. 5-8, a housing assembly or enclosure is shown as housing 200 according to an exemplary embodiment. The housing 200 contains a series of battery sections 202. The configuration of the housing 200 shown in FIGS. 5-8 may be utilized at the battery module 40 level, the subpack 30 level, and/or the battery pack 20 level. The housing 200 may be the pack housing 22 of the battery pack 20, and the battery sections 202 may represent the subpacks 30 within the pack housing 22. The housing 200 may be the housing 32 of one of the subpacks 30, and the battery sections 202 may represent the battery modules 40 within the housing 32. The housing 200 may be the housing 42 of one of the battery modules 40, and the battery sections 202 may represent the battery cells 50 within the housing 42. Accordingly, any description of the housing 200 may apply to the pack housing 22, the housings 32, and/or the housings 42. Similarly, any description of the battery sections 202 may apply to the subpacks 30, the battery modules 40, and/or the battery cells 50.

The housing 200 includes a first portion, outer portion, or exterior portion, shown as outer housing 210. The outer housing 210 includes a series of exterior or outer walls or dividers, shown as walls 212. In some embodiments, the walls 212 extend along all sides of the housing 200 (e.g., the front, rear, left, right, top, and bottom sides) such that the outer housing 210 is completely enclosed. As shown, the walls 212 are substantially rectangular, such that the outer housing 210 is shaped as a rectangular prism. In other embodiments, the outer housing 210 is otherwise shaped (e.g., cylindrical, spherical, frustoconical, etc.).

The housing 200 further includes a second portion, inner portion, or interior portion, shown as inner housing 220, that is received within the outer housing 210. The inner housing 220 includes a series of interior or inner walls or dividers, shown as walls 222. In some embodiments, the walls 222 extend along all sides of the housing 200 (e.g., the front, rear, left, right, top, and bottom sides) such that the inner housing 220 is completely enclosed. As shown, the walls 222 are substantially rectangular, such that the inner housing 220 is shaped as a rectangular prism. In other embodiments, the inner housing 220 is otherwise shaped (e.g., cylindrical, spherical, frustoconical, etc.).

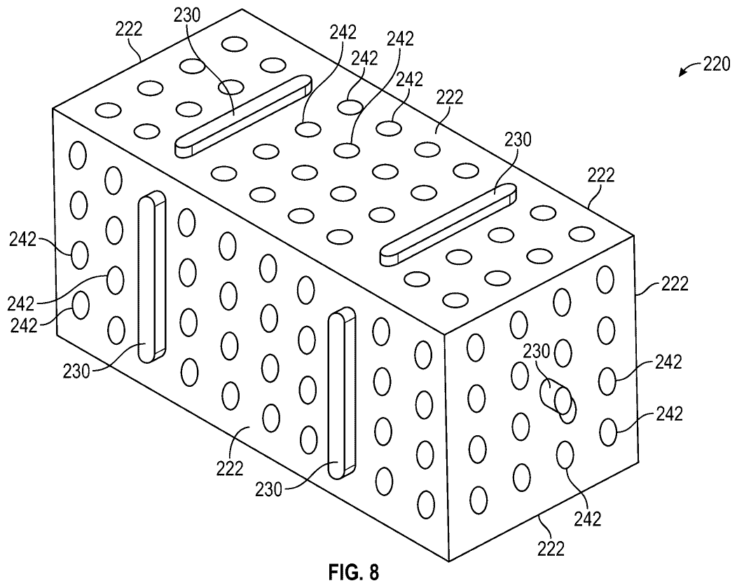

As shown in FIG. 8, the housing 200 further includes a series of standoffs, bosses, spacers, or baffles, shown as spacers 230, that extend between the walls 222 of the inner housing 220 and the walls 212 of the outer housing 210, spacing the inner housing 220 apart from the outer housing 210. The inner housing 220 may be fixedly coupled to the outer housing 210, such that the position of the inner housing 220 relative to the outer housing 210 is fixed. By way of example, the spacers 230 may fixedly couple the walls 212 to the walls 222.

A suppressant distribution volume, gap, space, volume, passage, channel, or plenum, shown as gap volume 232, is defined between the inner housing 220 and the outer housing 210. Specifically, the outer boundaries of the gap volume 232 are defined by the walls 212, and the inner boundaries of the gap volume 232 are defined by the walls 222. The gap volume 232 may define one continuous space, through which fluid (e.g., fire suppressant) can flow. In some embodiments, the gap volume 232 surrounds the inner housing 220 (e.g., on all sides). Accordingly, all of the outer faces of the inner housing 220 are exposed to the gap volume 232. The spacers 230 may be sized to prevent the spacers 230 from fluidly decoupling or otherwise isolating a portion of the gap volume 232. By way of example, gaps may be formed between the spacers 230 to facilitate fluid flow.

The inner housing 220 defines an interior volume or chamber, shown as inner volume 234. The inner volume 234 is defined by the walls 222 and extends inward from the walls 222. In some embodiments, the inner volume 234 is completely surrounded by the inner housing 220. The battery sections 202 are positioned within the inner volume 234 such that the battery sections 202 are contained within the inner housing 220.

The walls 212 define at least one inlet or passage, shown as inlet aperture 240. The inlet aperture 240 extends entirely through the corresponding wall 212, such that the inlet aperture 240 is fluidly coupled to the gap volume 232. As shown in FIG. 5, the inlet aperture 240 is fluidly coupled to a conduit of the distribution network 86. Accordingly, the distribution network 86 is fluidly coupled to the gap volume 232 through the inlet aperture 240. Although only one inlet aperture 240 is shown, in other embodiments the walls 212 define multiple inlet apertures 240.

The walls 222 define a series of perforations, inlets, or passages, shown as perforations 242. The perforations 242 extends entirely through the corresponding wall 222, such that the perforations 242 are each fluidly coupled to the gap volume 232 and the inner volume 234. Accordingly, the perforations 242 fluidly couple the gap volume 232 with the inner volume 234.

As shown, the perforations 242 are circular. In other embodiments, the perforations 242 are otherwise shaped. By way of example, the perforations 242 may be rectangular, triangular, elliptical, or otherwise shaped. In some embodiments, the perforations 242 are a series of thin slits formed in the walls 222.

The walls 222 may define a large quantity of the perforations 242. A large number of perforations 242 may facilitate an even distribution of fire suppressant throughout the inner volume 234. In some embodiments, one or more of the walls 222 each define at least two perforations 242 (e.g., 2, 10, 50, 100, 1000, etc.).

The perforations 242 may be spread throughout the walls 222 of inner housing 220. In some embodiments, each of the walls 222 define at least one perforation 242 (e.g., a front wall, a rear wall, a top wall, a bottom wall, a left wall, and a right wall each define at least one 242). In some embodiments, the perforations 242 are arranged in an array on the walls 222. By way of example, the perforations 242 may be arranged in a one-dimensional array (e.g., a line). By way of another example, the perforations 242 may be arranged in a two-dimensional array (e.g., in a grid forming rows and columns). The spacing between the perforations 242 may be uniform (e.g., such that a distance between each adjacent set of the perforations 242 is equal). Alternatively, the spacing between the perforations 242 may be variable. By way of example, a density (e.g., a quantity of perforations 242 in a given area along a surface of the inner housing 220) may vary based on the position of each perforation 242 relative to a hazard within the housing 200 (e.g., a battery section 202). In one such example, the density of the perforations 242 increase with the proximity of the perforations 242 to a hazard (e.g., such that more of the perforations 242 are present near the battery sections 202 than between the battery sections 202).

The size (e.g., diameter, cross-sectional area, etc.) of the perforations 242 may be uniform throughout the inner housing 220 (e.g., such that each of the perforations 242 has an equal size). Alternatively, the size of the perforations 242 may be variable. By way of example, the size of the perforations 242 may vary based on the position of each perforation 242 relative to a hazard within the housing 200 (e.g., a battery section 202). In one such example, the size of the perforations 242 increases with the proximity of the perforations 242 to a hazard (e.g., such that a greater collective cross-sectional area of the perforations 242 is present near the battery sections 202 than between the battery sections 202).

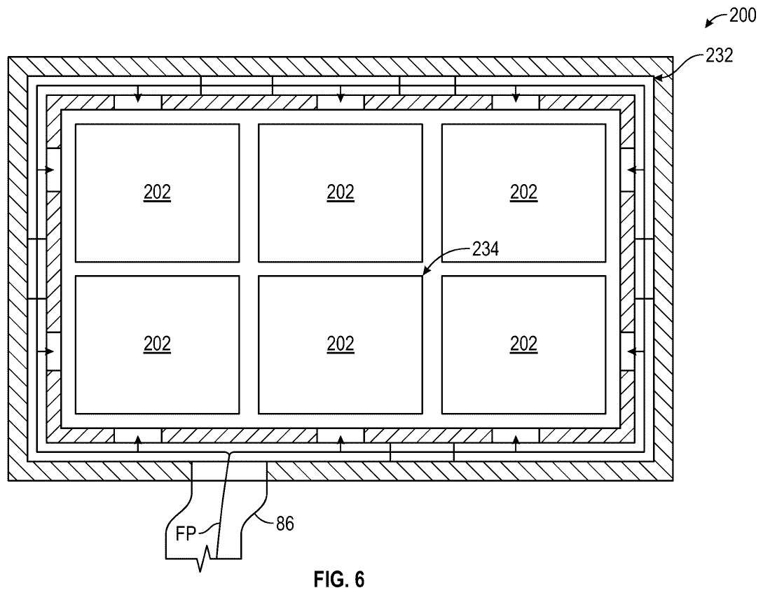

Referring to FIGS. 5 and 6, the arrangement of the inlet aperture 240, the gap volume 232, and the perforations 242 facilitates distribution of fire suppressant throughout the inner volume 234. FIG. 6 illustrates an exemplary flow path FP of the fire suppressant during operation. The flow of fire suppressant through the distribution network 86 may be controlled by the activator 84 (e.g., in response to a thermal event sensor 112 detecting a thermal event). The fire suppressant enters the housing 200 from a conduit of the distribution network 86. Specifically, the fire suppressant enters the gap volume 232 through the inlet aperture 240. The fire suppressant is then free to spread throughout the gap volume 232. The fire suppressant may partially or completely fill the gap volume 232. In some embodiments, the fire suppressant spreads sufficiently to reach all of the perforations 242.

Once the fire suppressant reaches a perforation 242, a portion of the fire suppressant within the gap volume 232 may split off from the rest of the fire suppressant and begin flowing through the perforation 242 into the inner volume 234. The remainder of the fire suppressant may continue flowing until encountering another perforation 242. The fire suppressant may flow through a greater number of perforations 242 as the gap volume 232 fills, such that the flow rate of fire suppressant into the inner volume 234 increases over time. Once the gap volume 232 is filled, the fire suppressant may flow through all of the perforations 242 simultaneously.

Due to the large quantity of perforations 242 and the positions of the perforations 242 spread along the walls 222, the housing 200 can effectively supply fluid at many locations throughout the inner volume 234 simultaneously. Accordingly, the housing 200 can quickly and effectively address thermal events throughout the inner volume 234 (e.g., fires at any of the battery sections 202). Additionally, because the gap volume 232 is contained between the inner housing 220 and the outer housing 210, the gap volume 232 requires no additional external conduits to distribute the fire suppressant, reducing the overall volume of the housing 200.

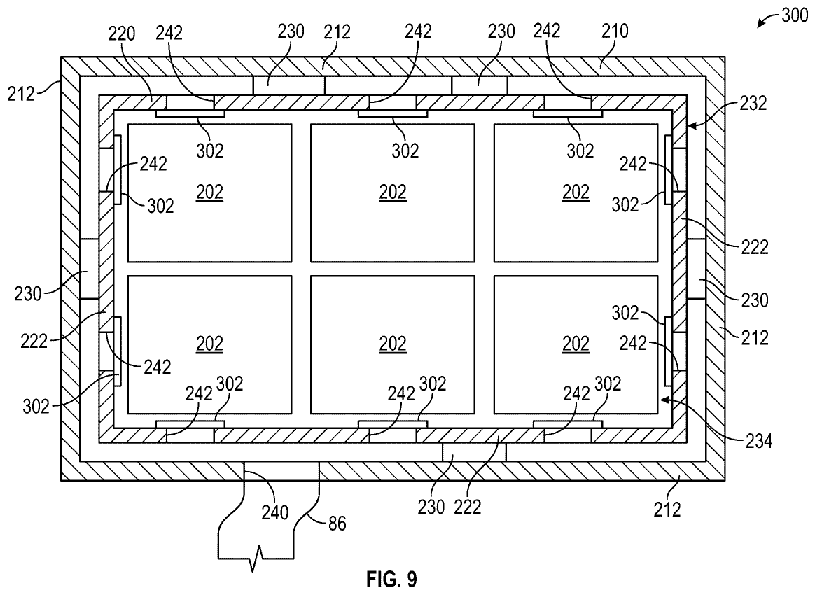

Referring to FIG. 9, a housing 300 is shown as an alternative embodiment of the housing 200. The housing 300 may be substantially similar to the housing 200, except as otherwise specified herein. The housing 300 is equipped with a series of membranes, coatings, or seals, shown as seals 302, coupled to the inner housing 220 and extending across the perforations 242. The seals 302 are reconfigurable from a sealing configuration or sealed state to a ruptured configuration or ruptured state. In the sealing state, the seals 302 fluidly decouple the gap volume 232 from the inner volume 234, preventing fire suppressant from entering the inner volume 234 through the perforations 242. In the ruptured state, the seals 302 are broken, punctured, torn, burst, or otherwise ruptured, fluidly coupling the gap volume 232 to the inner volume 234 and permitting fire suppressant to enter the inner volume 234 through the perforations 242.

As shown in FIG. 3, each of the perforations 242 is equipped with a seal 302. Accordingly, fire suppressant is prevented from passing from the gap volume 232 into the inner volume 234. In some embodiments, the seals 302 are used to control which of the perforations 242 supply the fire suppressant (e.g., a portion of the seals 302 remain in the sealed state during operation of the suppression system 80, such that only a subset of the perforations 242 supply the fire suppressant). In some embodiments, the seals 302 are used to prevent contaminants from entering the inner volume 234 when the suppression system 80 is not in use.

The seals 302 may be condition-sensitive, such that the seals 302 rupture in response to a predetermined condition. In some embodiments, the seals 302 are pressure-sensitive and rupture in response to experiencing a pressure differential greater than a threshold pressure. In some embodiments, the seals 302 are temperature-sensitive and rupture in response to experiencing greater than a threshold temperature. In some embodiments, the seals 302 are chemically-sensitive and rupture in response to contact with a predetermined substance (e.g., a substance released by a malfunctioning battery cell 50). Additionally or alternatively, the seals 302 may be signal-activated (e.g., by the controller 102). By way of example, the controller 102 may activate a solenoid that punctures the seal 302 in response to detection of a fire nearby.

In some embodiments, the seals 302 facilitate a localized distribution of fire suppressant based on the location of a hazard event (e.g., thermal event) within the inner volume 234. By way of example, a hazard event, such as a malfunctioning battery cell 50 or a fire, may affect the surrounding area in certain known ways, such as releasing thermal energy or chemicals. In some embodiments, the seals 302 are configured to be sensitive to conditions associated with a hazard event, such that the seals 302 rupture in response to experiencing those conditions. By way of example, the seals 302 may rupture in response to an elevated pressure caused by a hazard event, an elevated temperature caused by a hazard event, or contact with a predetermined substance released during a hazard event (e.g., battery acid). Accordingly, when a hazard event occurs, the seals 302 nearby the hazard event may rupture, while the seals 302 farther from the hazard event may remain intact. In such a situation, the fire suppressant enters the inner volume 234 nearby the hazard event, such that the fire suppressant is supplied only to a relatively small area (e.g., a portion of the inner volume 234) that contains the hazard event. Such a configuration may facilitate addressing the hazard event with a relatively small amount of agent, reducing the size of the suppressant container 82 required by the system 10.

In other embodiments, some or all of the seals 302 are signal-activated. The controller 102 may determine the location of a hazard event within the inner volume 234 (e.g., using the battery sensors 110 and/or the thermal event sensors 112). The controller 102 may then provide a signal to rupture the seals 302 nearest to the determined location of the hazard event, providing a localized distribution of the fire suppressant.

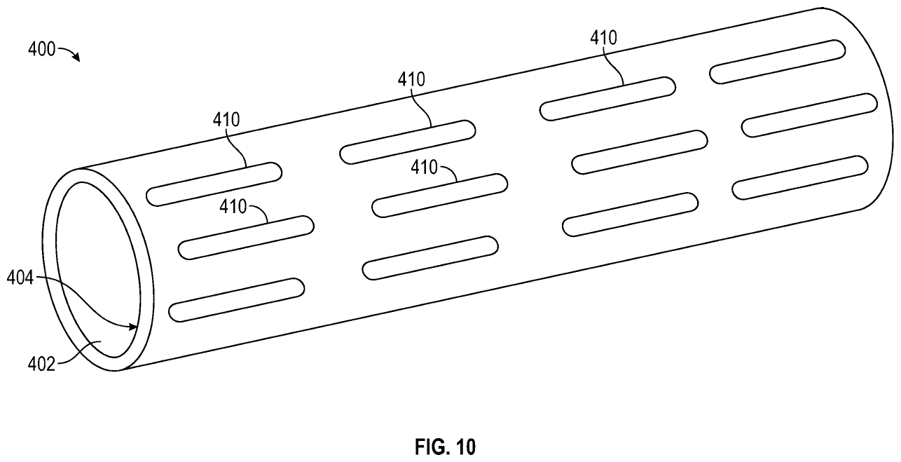

Referring to FIG. 10, a conduit 400 (e.g., a tube, a pipe, a hose, etc.) is shown according to an exemplary embodiment. The conduit 400 may be used in combination with the housing 200 and/or the housing 300, or with another battery system having a housing. The conduit 400 defines an opening, shown as inlet aperture 402 that is fluidly coupled to an inner volume or conduit volume, shown as gap volume 404, that is defined by the conduit 400. An end of the conduit 400 opposite the inlet aperture 402 may be sealed. The conduit 400 further defines a series of apertures, shown as perforations 410, that are spread along an exterior surface of the conduit 400.

In operation, the conduit 400 may function similarly to the housing 200. The conduit 400 may be positioned such that the perforations 410 are in fluid communication with the internal volume of the housing. By way of example, the conduit 400 may be coupled to a wall of the housing (e.g., using fasteners or adhesive), or may be formed as part of the wall (e.g., extruded during formation of the wall). Suppressant may be supplied through the inlet aperture 402 into the gap volume 404. The fire suppressant may move through the gap volume 404 and exit the gap volume 404 through the perforations 410 into the internal volume of the housing, where the fire suppressant can then address a thermal event.

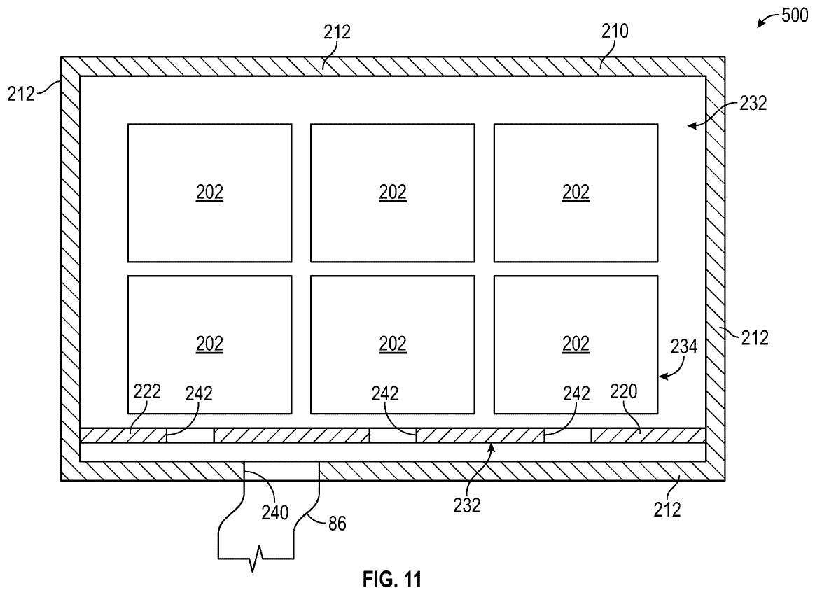

Referring to FIG. 11, a housing 500 is shown as an alternative embodiment of the housing 200. The housing 500 may be substantially similar to the housing 200, except as otherwise specified herein. In this embodiment, the inner housing 220 includes a single wall 222 that is fixedly coupled to and meets other walls 212 of the outer housing 210. As shown, the inner housing 220 only partially surrounds the inner volume 234. Accordingly, the inner volume 234 is defined in part by the wall 222, and also by the walls 212 of the outer housing 210. Due to the position of the wall 222, the gap volume 232 extends long along the bottom of the housing 500 as shown in FIG. 11, and the gap volume 232 does not completely surround the inner volume 234.

In other embodiments, the housing 500 includes multiple walls 222 that each form separate gap volumes 232 or portions of a continuous gap volume 232. By way of example, the housing 500 may include a wall 222 extending along the top of the housing 500 to form a first gap volume 500 along a top side of the housing 500, and another wall 222 extending along the bottom of the housing 500 to form a second gap volume 500 along a bottom of housing 500. By way of another example, the housing 500 may include a wall 222 along a bottom side of the housing 500 and another wall 222 along the right side of the housing 500 that form a single, continuous gap volume 232 that extends along the bottom and right sides of the housing 500.

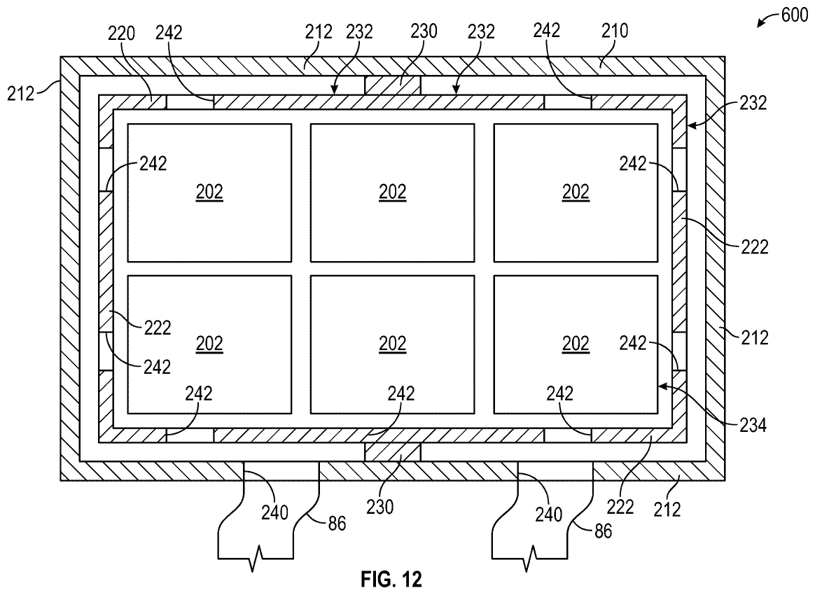

Referring to FIG. 12, a housing 600 is shown as an alternative embodiment of the housing 200. The housing 600 may be substantially similar to the housing 200, except as otherwise specified herein. In this embodiment, the housing 600 includes spacers 230 that extend between the walls 222 and the walls 212, forming a seal that separates the space between the inner housing 220 and the outer housing 210 into two separate gap volumes 232. The gap volumes 232 are fluidly decoupled from one another by the spacers 230, such that each gap volume 232 may distribute fire suppressant to a different part of the inner volume 234. In other embodiments, the housing 600 includes additional spacers 230 to define three or more gap volumes 232.

A similar effect may be achieved through the use of multiple conduits 400. In such embodiments, each conduit 400 may define a separate gap volume 404. Each conduit 400 may be routed differently to supply fire suppressant to a different area of the inner volume 234.

As shown in FIG. 12, the outer housing 210 defines two inlet apertures 240, each in fluid communication with one of the gap volumes 232. Each inlet aperture 240 is fluidly coupled to a different suppressant container 82 through a distribution network 86. Accordingly, each suppressant container 82 can supply fire suppressant to a different portion of the inner volume 234 through the corresponding gap volume 232. In some embodiments, the suppressant containers 82 each supply fire suppressant at different times or under different conditions (e.g., in response to reaching two different temperature thresholds). In some embodiments, the suppressant containers 82 each contain a different suppressant. By way of example, one suppressant container 82 may contain a liquid suppressant, while another suppressant container 82 contains a gaseous suppressant or a dry chemical suppressant.

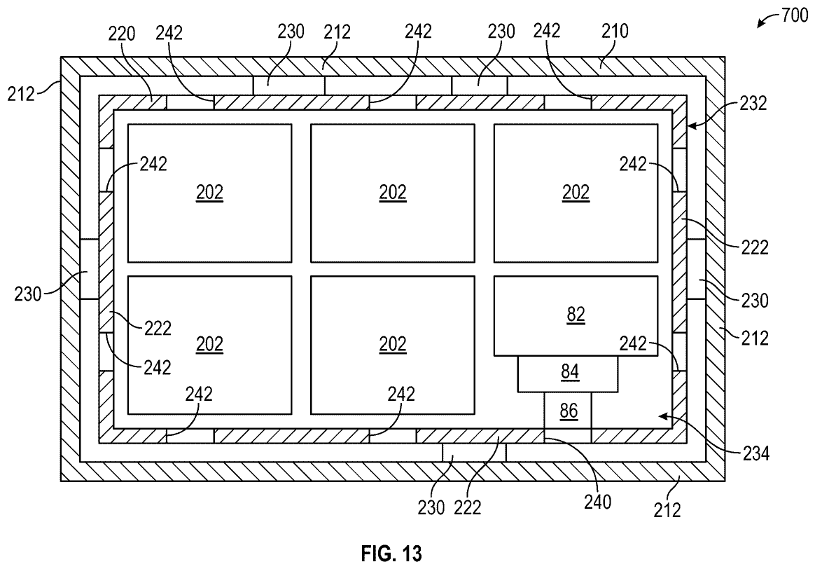

Referring to FIG. 13, a housing 700 is shown as an alternative embodiment of the housing 200. The housing 700 may be substantially similar to the housing 200, except as otherwise specified herein. In this embodiment, the housing 700 includes a suppressant supply 82 positioned within the inner volume 234. Because the suppressant supply 82 does not need to supply suppressant through the outer housing 210, the inlet aperture 240 is omitted from the outer housing 210. Instead, the inner housing 220 defines an inlet aperture 240 fluidly coupled to the suppressant supply 82 through a conduit of a distribution network 86 positioned within the inner volume 234.

In some embodiments, the fire suppression system 80 and/or a portion of the housing (e.g., the housing 200, the housing 300, the housing 500, the housing 600, the housing 700, etc.) are provided as a retrofit kit for providing fire suppression functionality to a battery module. By way of example, the battery module may include a housing having a series of ventilation apertures (e.g., louvers) positioned to air cool the components of the battery module. The retrofit kit may include the outer housing 210, and one or more battery modules may be placed within the outer housing 210. The housing of the battery module may act as the inner housing 220, with the ventilation apertures acting as the perforations 242.

### Configuration of the Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various exemplary embodiments is illustrative only. Additionally, any element disclosed in one embodiment may be incorporated or utilized with any other embodiment disclosed herein. For example, the arrangement of multiple battery packs 20 of the exemplary embodiment shown in at least FIG. 4 may be incorporated in the vehicle 130 of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A battery system, comprising:
a housing assembly including an inner wall and an outer wall, the housing assembly defining:
an inner volume;
a distribution volume extending between the inner wall and the outer wall, the inner wall extending between the inner volume and the distribution volume;
a first aperture and a second aperture each extending through the inner wall from the inner volume to the distribution volume; and
an inlet fluidly coupled to the distribution volume and configured to be fluidly coupled to a supply of fire suppressant; and
a battery section positioned within the inner volume.

2. The battery system of claim 1, wherein the housing assembly includes an inner housing including the inner wall and an outer housing including the outer wall, wherein the inner housing defines the inner volume, and wherein the inner housing extends within the outer housing.

3. The battery system of claim 2, wherein the housing assembly defines a first face and a second face opposite the first face, and wherein the first face and the second face are both exposed to the distribution volume.

4. The battery system of claim 2, wherein the inner housing is positioned entirely within the outer housing.

5. The battery system of claim 2, further comprising a spacer coupled to the inner housing and the outer housing and spacing the inner housing apart from the outer housing.

6. The battery system of claim 5, wherein the spacer extends through the distribution volume, from the inner wall to the outer wall.

7. The battery system of claim 1, further comprising a seal extending across the first aperture to prevent fluid flow through the first aperture, wherein the seal is configured to rupture to permit fluid flow through the first aperture.

8. The battery system of claim 7, wherein the seal is configured to rupture in response to experiencing a condition indicative of a hazard event.

9. The battery system of claim 8, wherein the condition indicative of the hazard event includes at least one of (a) a pressure differential greater than a threshold pressure, (b) a temperature greater than a threshold temperature, or (c) contact with a predetermined substance.

10. The battery system of claim 8, wherein the battery section is a first battery section, the seal is a first seal, and the hazard event is a hazard event associated with the first battery section, further comprising (a) a second battery section positioned within the inner volume and (b) a second seal extending across the second aperture to prevent fluid flow through the second aperture, wherein the second seal is configured to rupture in response to experiencing a condition indicative of a hazard event associated with the second battery section.

11. The battery system of claim 10, wherein the first seal is positioned a first distance from the first battery section, wherein the second seal is positioned a second distance from the second battery section, and wherein the second distance is larger than the first distance.

12. The battery system of claim 10, wherein the first seal is configured to rupture in response to an occurrence of the hazard event associated with the first battery section without rupturing the second seal.

13. The battery system of claim 1, wherein the battery section is one of a subpack, a battery module, or a battery cell.

14. The battery system of claim 1, further comprising the supply of the fire suppressant including a suppressant container and a valve configured to selectively fluidly couple the suppressant container to the inlet.

15. The battery system of claim 14, further comprising a conduit extending within the housing assembly, the conduit defining a conduit volume fluidly coupled to the suppressant container and a series of perforations fluidly coupling the conduit volume to the inner volume of the housing assembly.

16. A battery system, comprising:
an outer housing portion defining an inlet;
an inner housing portion positioned within the outer housing portion such that a gap volume is defined between the inner housing portion and the outer housing portion, the inner housing portion defining an inner volume and a perforation fluidly coupling the inner volume to the gap volume;
a battery section positioned within the inner volume; and
a suppressant container fluidly coupled to the inlet, wherein the suppressant container is configured to supply fire suppressant along a flow path extending through the inlet, the gap volume, and the perforation and into the inner volume.

17. The battery system of claim 16, wherein the perforation is a first perforation, wherein the inner housing portion defines a second perforation fluidly coupling the inner volume to the gap volume, and wherein the flow path splits within the gap volume and extends through both the first perforation and the second perforation.

18. The battery system of claim 16, further comprising a seal extending across the perforation to prevent fluid flow through the perforation, wherein the seal is configured to rupture in response to a hazard event associated with the battery section to permit fluid flow through the perforation.

19. The battery system of claim 16, wherein the gap volume surrounds the inner housing portion.

20. A battery system, comprising:
an outer housing defining an inlet;
an inner housing positioned within the outer housing such that a gap volume is defined between the inner housing and the outer housing, the inner housing defining an inner volume, a first aperture fluidly coupling the inner volume to the gap volume, and a second aperture fluidly coupling the inner volume to the gap volume, wherein the inner housing has a first face and an opposing second face each exposed to the gap volume;
a first battery section and a second battery section each positioned within the inner volume;
a first seal extending across the first aperture and configured to rupture in response to a hazard event associated with the first battery section;
a second seal extending across the second aperture and configured to rupture in response to a hazard event associated with the second battery section; and
a suppressant container fluidly coupled to the inlet, wherein the suppressant container is configured to supply fire suppressant to the inner volume through the inlet, the gap volume, the first aperture, and the second aperture.
